(19) United States
(12) Patent Application Publication
(10) Pub. No.: US 2022/0351070 A1
(43) Pub. Date: Nov. 3, 2022

(54) CONTEXTUAL BANDIT MACHINE LEARNING SYSTEMS AND METHODS FOR CONTENT DELIVERY

(71) Applicant: INTUIT INC., Mountain View, CA (US)

(72) Inventors: Chang LIU, Edmonton (CA); Babak AGHAZADEH, Mountain View, CA (US); Allegra Aren LATIMER, Mountain View, CA (US)

(73) Assignee: INTUIT INC., Mountain View, CA (US)

(21) Appl. No.: 17/245,772

(22) Filed: Apr. 30, 2021

(51) Int. Cl. G06N 20/00; G06F 3/14

(52) U.S. Cl. CPC G06N 20/00; G06F 3/14

(57) ABSTRACT

A processor may receive a request payload from an external device and data describing a plurality of user interface (UI) elements configured to be presented in a UI of the external device. The request payload may include a user identifier. The processor may generate a user feature vector from the user identifier. Using a contextual bandit machine learning (ML) model that takes the user feature vector and the data describing the plurality of UI elements as input, the processor may select at least one of the plurality of UI elements as at least one recommended UI element. The at least one recommended UI element may be presented in the UI of the external device. The processor may receive event data indicating a user interaction with the at least one recommended UI element in the UI of the external device. The ML model may be trained using the event data.

### BACKGROUND

Computer user interfaces (UIs) often present information that can vary dynamically. For example, web browsers serving pages, apps, and/or other software that facilitates network data transfer often receive variable data for display in their UIs. Specifically, these programs can present advertisements, offers, media, and/or other content items dynamically, so that when a user accesses the browser or app multiple times, they might see multiple different ads, offers, or media elements. Selections may appear random to the user, but in many cases, they are actually chosen deliberately. For example, selections may be curated, ranked, or otherwise specifically designated for display at set times or in set orders. In other cases, selections may be prioritized according to various algorithmic approaches. Many present state-of-the art systems recommend offers ranked based on a curated priority list, which doesn't consider user preference, behavior, or context.

### BRIEF DESCRIPTIONS OF THE DRAWINGS

FIG. 1 shows an example machine learning content delivery system according to some embodiments of the disclosure.

FIG. 2 shows an example content delivery process according to some embodiments of the disclosure.

FIG. 3 shows an example user feature vector generation process according to some embodiments of the disclosure.

FIG. 4 shows an example offer data generation process according to some embodiments of the disclosure.

FIG. 5 shows an example recommendation process according to some embodiments of the disclosure.

FIG. 6 shows an example training process according to some embodiments of the disclosure.

FIG. 7 shows a computing device according to some embodiments of the disclosure.

### DETAILED DESCRIPTION OF SEVERAL EMBODIMENTS

Embodiments described herein employ a contextual bandit model to provide improved, automatic content presentation. Some of the specific examples described below relate to content presentation that includes financial offer recommendation in the context of a financial app, but it will be apparent that the systems and methods described herein can be modified to present other content. The contextual bandit model can include at least two components, a reward model and an exploration algorithm. The reward model is a linear model that takes as input a set of user features and another set of contextual features. For example, user features can include attributes that describe a user's financial profile and spending behaviors. Contextual features can include geolocation, time of day and day of the week, etc. Together, these features can enable the model to make personalized recommendations based on the given context. By feeding features into the reward model, embodiments described herein can deliver a probability score (aka, a reward estimate) for each available product that indicates the likelihood the current user would click on that product.

Users of UIs are expected to respond best to relevant, personalized offers, and ranked and/or curated offers are often mostly irrelevant to their needs. Disclosed systems and methods can recommend offers to customers that are personalized based on their personal information (e.g., a financial profile) and context, in order to help customers find products that suit their needs better. In the context of financial offers, various products have different qualification requirements, whereas users have different financial backgrounds and proclivities for financial products. Moreover, online systems can be very complex, with many different ad placements throughout a UI and with each placement configured differently from each other. Another challenge is the shift of user preference. A model that learned from past data may not continue to perform well in the long-term future, due to changes in a user's situation (e.g., financial situation), goals, and/or needs.

To address these challenges, embodiments described herein may provide robust machine learning (ML) systems and methods that can recommend personalized offers to users at the right place and the right time, including bandit algorithms. Unlike traditional supervised ML models that learn on a batch of examples offline and make predictions for a test set by selecting the class or item with the highest score, bandit algorithms learn from one example at a time with an exploration strategy that sometimes recommends products that do not have the highest estimated reward. In the embodiments described herein, this is manifested by presenting offers to a user that are not necessarily ranked as most likely to be clicked on. Observing the user's reaction to such offers allows the model to learn and improve, as described in detail below. This approach can address the challenges of recommendation complexity, personalization, and shifting user preference.

Moreover, the described systems and methods provide technical improvements such as fast retrieval of user data and, therefore, fast response times to content requests. For example, compared to other contextual bandit recommendation approaches such as LinUCB, disclosed embodiments can deal with a very high dimensional user representation (e.g., more than 216 user attributes used for recommendation) by leveraging an on-disk user database with zero memory usage, thereby realizing low latency. Database management systems such as SQLite can be used to perform user feature extraction at inference time with fast index-based lookup and massive parallelization. As an example outcome, embodiments described herein can serve a traffic of over 400 TPS (transaction per second) at an average response time of 60 ms. Furthermore, disclosed embodiments involve a new cascaded exploration strategy, wherein cascading a more aggressive exploration algorithm such as softmax with a less aggressive algorithm such as epsilon-greedy provides a balance between efficient exploration and full support for available actions. Offline analysis such as counterfactual evaluation of alternative policies may require the full support of actions available in the policy being evaluated to reach an unbiased point estimate of alternative policy performance.

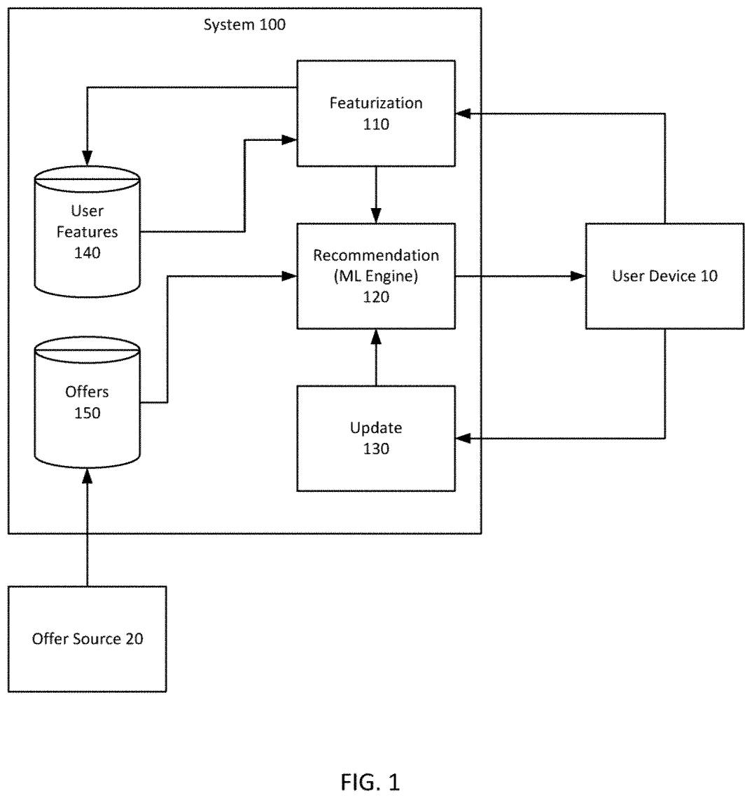

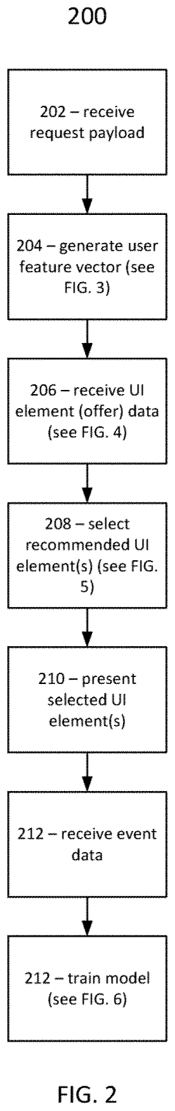

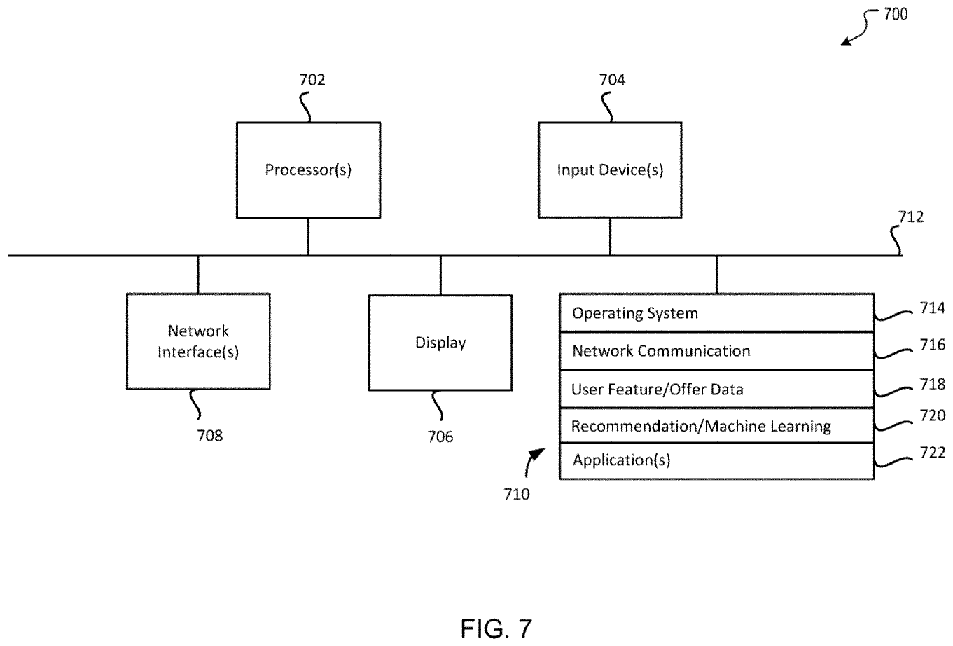

FIG. 1 shows an example ML content delivery system 100 according to some embodiments of the disclosure. System 100 may include a variety of hardware, firmware, and/or software components that interact with one another and with user devices 10 and/or offer sources 20. For example, system 100 includes featurization processing 110, recommendation/ML processing 120, and update processing 130, each of which may be implemented by one or more computers (e.g., as described below with respect to FIG. 7). System 100 also includes non-transitory memory which may include one or more databases such as user feature database 140 and offer database 150. As described in detail below, user device 10 in communication with system 100 (e.g., through the Internet or another network or networks) can request data from system 100. This can include a request for one or more offers to be displayed in a UI of user device 10. Featurization processing 110 uses the request payload from user device 10 to obtain a feature vector from user feature database 140. Using the feature vector, recommendation/ML processing 120 can recommend one or more of the offers from offer database 150 and send the recommended offer(s) to user device 10 for presentation in the UI. User device 10 can report user interactions with the offer(s) to update processing 130 and/or update processing 130 can detect such interactions from network traffic data. Update processing 130 can update the model used by recommendation/ML processing 120 based on the interactions. FIGS. 2-6 illustrate the functioning of system 100 in detail.

User device 10, offer source 20, system 100, and individual elements of system 100 (featurization processing 110, recommendation/ML processing 120, update processing 130, user feature database 140, and offer database 150) are each depicted as single blocks for ease of illustration, but those of ordinary skill in the art will appreciate that these may be embodied in different forms for different implementations. For example, system 100 may be provided by a single device or plural devices, and/or any or all of its components may be distributed across multiple devices. In another example, while featurization processing 110, recommendation/ML processing 120, update processing 130, user feature database 140, and offer database 150 are depicted separately, any combination of these elements may be part of a combined hardware, firmware, and/or software element. Moreover, while one user device 10 and one offer source 20 are shown, in practice, there may be multiple user devices 10, multiple offer sources 20, or both.

FIG. 2 shows an example content delivery process 200 according to some embodiments of the disclosure. System 100 can perform process 200 to deliver UI elements (e.g., offers) to user device 10 and to process the user's reaction to the UI elements delivered. For example, ML engine 120 can recommend offers and train itself based on how the offers are received by a user of user device 10, as described in detail below.

At 202, system 100 can receive a request payload from an external device (e.g., user device 10). The request payload can include a user identifier. For example, the user of user device 10 can log in to the device, an app on the device, a website, etc. with an identifier (AuthID). The identifier is sent from user device 10 to system 100 as the request payload or as a part of the request payload. For example, the request payload can be an explicit request for a UI element (e.g., an offer) to be displayed in the UI of user device 10, or it may be a more general payload (e.g., a login from user device 10 to system 100 or a service provided by system 100).

In some embodiments, the request payload can further include contextual data. For example, the request payload may include not only the identifier, but also features such as a time stamp, a user device 10 location, apps running on user device 10, an app used to send the request payload, etc.

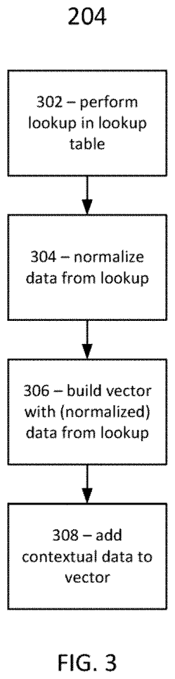

At 204, system 100 can generate a user feature vector from the user identifier. For example, as described in detail with respect to FIG. 3 below, system 100 can perform a fast lookup in user feature database 140 using the user identifier. User feature database 140 may include features of the user that are associated with the user identifier in the data structure. System 100 can assemble the features returned in the lookup into a vector of length N, where N is the number of features returned. This process is described in detail below.

In some embodiments, generating the user feature vector can further include adding the contextual data to data extracted from a database. For example, the vector may include the features from user feature database 140 plus the features indicated in the contextual data (e.g., defined user features plus contextual user features of time, location, apps, etc.), giving a vector of length M=(N+C), where C is the number of features indicated in the contextual data.

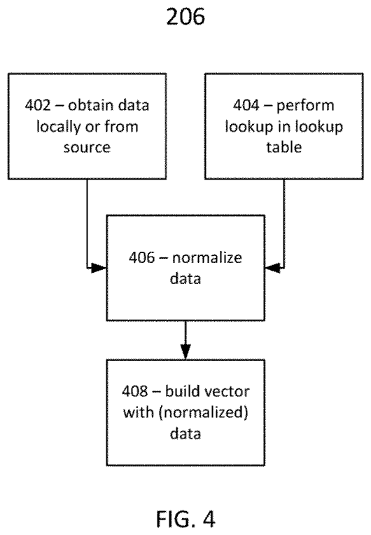

At 206, system 100 can receive data describing a plurality of UI elements configured to be presented in a UI of the external device (e.g., user device 10). In some embodiments, system 100 may receive elements directly from one or more offer sources 20 and/or may have them available in local memory (e.g., when the number of available elements is small, this may be efficient). In other embodiments, system 100 can perform a fast lookup in offer database 150 similar to that performed in user feature database 140 above. This is described in detail below with respect to FIG. 4.

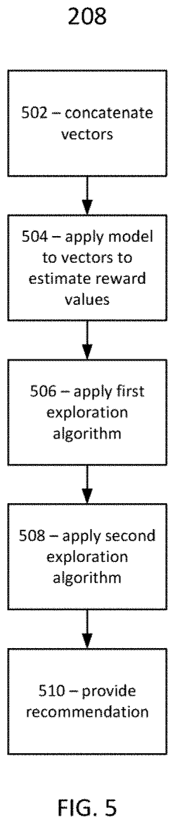

At 208, system 100 can select at least one of the plurality of UI elements as at least one recommended UI element. This can be done using a contextual bandit ML model that takes the user feature vector and the data describing the plurality of UI elements as input. This is described in detail below with respect to FIG. 5.

At 210, system 100 can cause the at least one recommended UI element to be presented in the UI of the external device (e.g., user device 10). For example, system 100 can send the recommended UI element to user device 10, can send data indicating where user device 10 can retrieve the recommended UI element (e.g., an external network host) to user device 10, can send a command to user device 10 to display the recommended UI element which it already has locally, etc. In any case, user device 10 can display the recommended UI element in its UI in response.

At 212, system 100 can receive event data indicating a user interaction with the at least one recommended UI element in the UI of the external device (e.g., user device 10). For example, this can be “reward” data, where a user interaction (e.g., a click) with the UI element gets a reward (e.g., value=1) and a failure of the user to interact (e.g., the user ignores the element) does not get a reward (e.g., value=0). Such rewards can be identified from click records and/or from event logs, where event logs include entries such as “impression” for presentation of a UI element, “click” for a click, “dwell time” for time UI element is displayed (e.g., time during which it is not scrolled past, indicating it is potentially being read), etc. As such, the event data can indicate that the user interaction indicates that the at least one recommended UI element was correctly predicted by the ML model.

In some embodiments, user device 10 can directly report when a user interaction takes place. However, some embodiments may use batch updating to avoid excessive transmission over the network and to avoid false negatives. For example, given a large enough set of user devices 10 interacting with system 100, ad hoc reporting of user interactions may be bandwidth intensive. Also, a user may not necessarily interact with a UI element as soon as it is presented, but instead may be busy with another task and may click on the UI element later, such that it would be a false negative to report a value=0 too quickly. As such, these embodiments do not send event data to system 100 right away. Instead, the data may be cached or collected in some bulk manner (e.g., as clickstream data over a given period of time), with a batch update to system 100 occasionally or periodically (e.g., every 24 hours or some other interval).

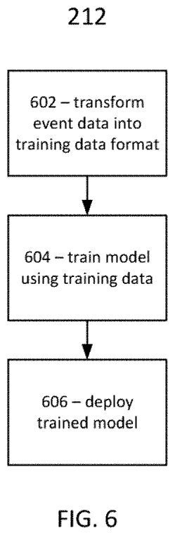

At 214, system 100 can train the ML model using the event data. As described below in detail with respect to FIG. 6, event data indicating rewards for user interactions can be used to train the ML model, so the ML model can update its predictions based on which users clicked on which UI elements. As such, when process 200 is performed in the future, recommendations made at 208 can be more accurate and allow user device 10 to present information to a user that is more relevant to the user's interests. This is not only useful to the user, but also is more efficient, as it allows appropriate data to be selected and sent to user device 10 more promptly than with a less effective recommendation method or with a random selection, for example.

FIG. 3 shows an example user feature vector generation process 204 according to some embodiments of the disclosure. As noted above, system 100 can generate a user feature vector for use in selecting recommended UI elements with ML processing.

At 302, system 100 can perform a lookup in a lookup table of user feature database 140. For example, some embodiments may be provisioned by building a user feature lookup table in order to conserve memory. Such a table could be built using SQLite and/or other database management systems. In this way, system 100 may be able to fast retrieve a user feature vector by looking up the identifier from the request payload (e.g., AuthID). Since the lookup table is a database on disk, which has zero memory consumption, system 100 may spin up parallel threads and enable massive parallel computing to perform the lookup. For example, in a table where each user (of approximately 11 million total users) has the features of Table 1 below, 60 parallel threads may return results in well below 100 milliseconds, making a user feature lookup in response to a request payload feasible in terms of computational efficiency and response time, yielding a technical and functional improvement over other lookup techniques.

TABLE 1
Example User Features

‘student_loans_total_balance’,
‘mortgages_total_balance’,
‘credit_card_total_balance’,
‘other_loan_total_balance’,
‘auto_loan_total_balance’,
‘number_student_loans’,
‘number_mortgages’,
‘number_credit_cards’,
‘number_other_loans’,
‘number_auto_loans’,
‘own_a_home_ind’,
‘has_student_loan_ind’,
‘vantage_creditscore’,
‘vantage_creditscore_band_index’,
‘creditscore’,
‘creditscore_band_index’,
‘credit_record_bankruptcy_ind’.
‘credit_record_collection_acct_ind’,
‘credit_record_legal_item_ind’,
‘credit_record_wage_attachment_ind’,
‘number_payhist_pay_as_agreed’,
‘number_payhist_zerobalance’,
‘number_payhist_late30days’,
‘number_payhist_late60days’,
‘number_payhist_late120days’,
‘number_payhist_late150days’,
‘number_payhist_late180days’,
‘number_payhist_morethan4pastdue’,
‘number_payhist_chapt13’,
‘number_payhist_collectionacc’,
‘number_payhist_chargeoff’,
‘number_payhist_repossession’,
‘number_payhist_toonewtorate’,
‘number_payhist_wageearnerplan’,
‘w2_401k_total_amount’,
‘w2_roth_total_amount’,
‘w2_salary_reduc_total_amount’,
‘w2_srsep_total_amount’,
‘w2_defrd_comp_total_amount’,
‘w2_simp_ira_total_amount’,
‘w2_roth_sal_reduc_total_amount’,
‘w2_roth_defrd_comp_total_amount’,
‘pension_total_amount’,
‘taxable_pension_total_amount’,
‘bus_expense_pension_total_amount’,
‘self_employment_retirement_total_amount’,
‘ira_deduction_total_amount’,
‘ira_taxable_total_amount’,
‘ira_distributions_total_amount’,
‘retirement_savings_credit_total_amount’,
‘additional_tax_retirement_total_amount’,
‘tax_year’,
‘household_size’,
‘number_w2’,
‘income_total_amount’,
‘salaries_and_wages_amount’,
‘salaries_and_wages_ind’,
‘interest_income_ind’,
‘dividends_income_ind’,
‘alimony_income_ind’,
‘business_income_ind’,
‘income_from_other_gains_ind’,
‘farm_income_ind’,
‘ira_income_ind’,
‘pension_income_ind’,
‘scheduleE_income_ind’,
‘unemployment_income_ind’,
‘social_security_income_ind’,
‘other_income_ind’,
‘health_insurance_ind’,
‘life_insurance_ind’,
‘auto_insurance_ind’,
‘home_insurance_ind’,
‘last12months_total_income_amount’,
‘last12months_paycheck_income_amount’,
‘last12months_cost_of_living_amount’,
‘last12months_discretionary__expenses_amount’.
‘last12months_total_expenses_amount’,
‘previousmonth_total_income_amount’.
‘previousmonth_paycheck_income_amount’.
‘previousmonth_cost_of_living_amount’,
‘previousmonth_discretionary_expenses_amount’,
‘previousmonth_total_expenses_amount’,
‘lastyear_total_income_amount’,
‘lastyear_paycheck_income_amount’,
‘lastyear_cost_of_living_amount’,
‘lastyear_discretionary_expenses_amount’,
‘lastyear_total_expenses_amount’,
‘lastqtr_total_income_amount’,
‘lastqtr_paycheck_income_amount’,
‘lastqtr_cost_of_living_amount’,
‘lastqtr_discretionary_expenses_amount’,
‘lastqtr_total_expenses_amount’,
‘cost_of_living_expenses_percent_of_income’,
‘discretionary_expenses_percent_of_income’,
‘resiliency_score’,
‘number_income_months_over_normal’.
‘number_income_months_under_normal’.
‘income_volatility_ratio’,
‘number_paycheck_months_over_normal’,
‘number_paycheck_months_under_normal’,
‘paycheck_volatility_ratio’,
‘number_cost_of_living_months_over_normal’,
‘number_cost_of_living_months_under_normal’,
‘cost_of_living_volatility_ratio’,
‘number_discretionary_expenses_months_over_normal’,
‘number_discretionary_expenses_months_under_normal’,
‘discretionary_expenses_volatility_ratio’,
‘number_total_expenses_months_over_normal’,
‘number_total_expenses_months_under_normal’,
‘total_expenses_volatility_ratio’,
‘savings_rate’,
‘emergency_fund_balance’,
‘number_cost_of_living_months_emergencybal_covers’,
‘age’,
‘householdchildren’,
‘householdadults’,
‘number_closed_accounts’,
‘number_bank_accounts’,
‘number_investment_accounts’,
‘number_insurance_accounts’,
‘number_realestate_accounts’,
‘number_vehicle_accounts’,
‘number_cash_accounts’,
‘number_cd_bank_accounts’,
‘number_checking_bank_accounts’,
‘number_moneymarket_bank_accounts’,
‘number_other_bank_accounts’,
‘number_savings_bank_accounts’,
‘number_overdraft_bank_accounts’,
‘number_cashmanagement_bank_accounts’,
‘minimum_creditlimit’,
‘maximum_creditlimit’,
‘median_creditlimit’,
‘average_creditlimit’,
‘minimum_credit_utilization’,
‘maximum_credit_utilization’,
‘median_credit_utilization’,
‘average_credit_utilization’,
‘total_credit_limit’,
‘total_available_credit’,
‘overall_credit_utilization’,
‘number_total_loan’,
‘number_homeequity_loan’,
‘number_installment_loan’,
‘number_lifeinsurance_loan’,
‘number_lineofcredit_loan’,
‘number_personal_loan’,
‘number_loans’,
‘number_total_investments’,
‘number_taxable_investments’,
‘number_401k_investments’.
‘number_taxablebrokerage_investments’,
‘number_traditionalIRA_investments’,
‘number_rothIRA_investments’,
‘number_other_investments’,
‘number_nontaxable_investments’,
‘number_employer_investments’.
‘number_rolloverIRA_investments’,
‘number_529_investments’,
‘number_403B_investments’,
‘number_unknown_investments’,
‘number_total_property’,
‘number_otherproperty_assets’,
‘number_vehicle_assets’,
‘number_realestate_assets’,
‘number_otherproperty_liability’.
‘invest_stash_ind’.
‘invest_fundrise_ind’.
‘present_bias’.
‘personal_loan_clicks_90days’.
‘personal_loan_views_90days’.
‘auto_loan_clicks_90days’,
‘auto_loan_views_90days’,
‘brokerage_clicks_90days’,
‘brokerage_views_90days’,
‘ira_clicks_90days’,
‘ira_views_90days’,
‘cd_clicks_90days’,
‘cd_views_90days’,
‘home_insurance_clicks_90days’,
‘home_insurance_views_90days’,
‘credit_cards_clicks_90days’,
‘credit_cards_views_90days’,
‘micro_investing_clicks_90days’,
‘micro_investing_views_90days’,
‘student_loan_clicks_90days’,
‘student_loan_views_90days’,
‘checking_clicks_90days’,
‘checking_views_90days’,
‘life_insurance_clicks_90days’,
‘life_insurance_views_90days’,
‘auto_insurance_clicks_90days’,
‘auto_insurance_views_90days’,
‘mortgage_clicks_90days’,
‘mortgage_views_90days’,
‘savings_clicks_90days’,
‘savings_views_90days’,
‘in_product_seconds’,
‘topic_transactions_seconds’,
‘topic_goals_seconds’,
‘topic_trends_seconds’,
‘topic_investment_seconds’,
‘topic_budgets_seconds’,
‘topic_bills_seconds’,
‘topic_marketplace_seconds’,
‘topic_credit_score_seconds’,
‘hotel_dollars_90days’,
‘hotel_count_90days’,
‘travel_dollars_90days’,
‘travel_count_90days’,
‘food_dollars_90days’,
‘food_count_90days’,
‘groceries_dollars_90days’,
‘groceries_count_90days’

At 304, in some embodiments, system 100 can normalize the data returned by the lookup at 302. In such embodiments, separate respective user feature data entries can have different value scales and/or ranges, so to avoid weighting entries unevenly, the data can be normalized. In the example of Table 1, it will be apparent that entries like household_size, age, creditscore, travel_dollars_90days, and mortgages_total_balance, to name a few, will have very different value ranges and scales. System 100 can apply a normalization technique or algorithm to the data to adjust for this, for example feature scaling by subtracting the mean and dividing by the standard deviation.

At 306, system 100 can build a user feature vector with the data returned by the lookup at 302 or, if normalized, the normalized data generated at 304. System 100 can assemble the features into a vector of length N, where N is the number of features returned and/or normalized.

At 308, system 100 can add the contextual data to the user feature vector. As described above, the request payload can include contextual data in some embodiments. Continuing the Table 1 example, contextual data that can be added to the user feature vector could include, for example, time_of_day, day_of_week, device_type, and/or placement_id. System 100 can optionally normalize the contextual data in the same manner as the returned data. In cases where contextual data is available, the resulting vector can include the features from user feature database 140 (as normalized, if applicable) plus the features indicated in the contextual data (as normalized, if applicable), giving a vector of length M=(N+C), where C is the number of features indicated in the contextual data.

FIG. 4 shows an example offer data generation process 206 according to some embodiments of the disclosure. As with the user features, system 100 can generate UI element vectors for use in selecting recommended UI elements with ML processing. In the examples of FIG. 4, the UI element vectors are offer vectors for offers presented in the UI, but it will be understood that other UI elements vectors may be generated in the same fashion in other embodiments.

At 402 and/or 404, system 100 can obtain offer (UI element) data. Offer data can be obtained for multiple offers (e.g., 10 offers) so that these offers can be ranked and recommended by the recommendation process as described below. For example, at 402, system 100 may receive a list of elements (e.g., a list of element IDs) from which to choose from an external source. In some embodiments, this can be part of the request payload received at 202. In other embodiments, this can be obtained from another source (e.g., offer sources 20 or some business logic configured to select element IDs based on rules, ML, or even randomly).

The complete set of possible offers may be available from one or more offer sources 20 and/or may be available in local memory (e.g., when the number of available elements is small, this may be efficient). In some embodiments, the complete set of possible offers can be in offer database 150, and at 404, system 100 can perform a fast lookup in offer database 150 similar to that performed in user feature database 140 above. For example, some embodiments may be provisioned by building an offer feature lookup table in order to conserve memory. Such a table could be built using SQLite and/or other database management systems. In this way, system 100 may be able to fast retrieve offer feature vectors by looking up offer identifiers. Since the lookup table is a database on disk, which has zero memory consumption, system 100 may spin up parallel threads and enable massive parallel computing to perform the lookup.

At 406, in some embodiments, system 100 can normalize the data obtained at 402 and/or 404. In such embodiments, separate respective offer feature data entries can have different value scales and/or ranges, so to avoid weighting entries unevenly, the data can be normalized. System 100 can apply a normalization technique or algorithm to the data to adjust for this, for example feature scaling by subtracting the mean and dividing by the standard deviation.

At 408, system 100 can build an offer feature vector for each offer with the data returned by the obtained at 402 and/or 404 or, if normalized, the normalized data generated at 406. System 100 can assemble the features into a vector of length L, where L is the number of features returned and/or normalized.

FIG. 5 shows an example recommendation process 208 according to some embodiments of the disclosure. System 100 can select at least one of the plurality of UI elements as at least one recommended UI element. This can be done using a contextual bandit ML model that takes the user feature vector and the data describing the plurality of UI elements as input.

At 502, system 100 can concatenate vectors. Specifically, system 100 can concatenate the user feature vector and each respective entry of the data describing the plurality of UI elements (e.g., each offer feature vector built by process 206). Each such vector will have all features of the user feature vector and all features of one of the offer feature vectors. This can yield as many vectors as there are offer feature vectors. For example, if there are ten offer feature vectors, there will be ten concatenated vectors, with each concatenated vector being a combination of the user feature vector and a respective one of the offer feature vectors. The concatenations of the user feature vector and the respective entries are ready to be input into the ML model.

At 504, system 100 can apply an ML model to each vector from 502 to estimate respective current reward values of each of the plurality of UI elements. For example, system 100 may apply a logistic regression or linear regression model and regress vectors from 502 on a continuous value to get an estimate of the reward for each offer, where the reward indicates a click or other interaction by the user in the UI (e.g., reward: 1=click, 0=no click). A higher reward estimate indicates a higher likelihood of user interaction, based on the content of the vector and the processing using the model. In logistic regression, the outputs of the model can include estimates of click propensity in the range [0,1]. In linear regression, outputs can still be generally in this range but not bounded by 0 and 1. In some embodiments, different algorithms may be used (e.g., classification rather than regression, etc.).

It is possible to simply take the content having the highest reward estimate and present it to the user, but system 100 may also perform exploration. Exploration allows the model to be further trained by evaluating offers that are not necessarily those most highly recommended, as explained in detail below with respect to FIG. 6.

Thus, system 100 makes an initial selection of at least one recommended UI element according to the current reward value and an exploration strategy. To that end, at 506, system 100 can apply a first exploration algorithm to the estimates from 504. For example, this algorithm may recommend offers stochastically following a softmax exploration strategy. This means the more confident the reward model is on a candidate element, the higher probability this element will be recommended. The output of the softmax exploration strategy can be a probability distribution of all the possible UI elements, with a sum of all probabilities being equal to 1. For example, the following formula may be used, where i indicates a UI element (or ID), zi indicates the output of the model, and K and β are hyperparameters:

$${σ ( z )}_{i} = \frac{{e}^{β {z}_{i}}}{{\sum }_{j = 1}^{K} {e}^{β {z}_{j}}} or {σ ( z )}_{i} = \frac{{e}^{- β {z}_{i}}}{{\sum }_{j = 1}^{K} {e}^{- β {z}_{i}}} for i = 1 , … , K .$$

At 508, system 100 can apply a second exploration algorithm to the estimates from 506. For example, on top of the softmax exploration, system 100 may add an epsilon-greedy exploration in order to maintain a certain degree of pure exploration and ensure full probability support of available actions. For example, an epsilon-greedy algorithm applied to the output of softmax probability vector [0.8, 0.2] (two offers: a and b) can work as follows: with probability epsilon, pick an offer randomly, hence each offer has 50% of chance being selected; with probability 1-epsilon, pick an offer following the probability vector of the softmax output (i.e., 80% of chance selecting offer a, and 20% of chance selecting offer b).

After the exploration, system 100 may have translated the reward estimate into a probability distribution where the total probabilities of all of the offer options add up to 1. At 510, system 100 can provide a recommendation. System 100 can provide the recommendation by sampling from the probability distribution to choose the action to recommend (i.e., the UI element to present).

FIG. 6 shows an example training process 212 according to some embodiments of the disclosure. Event data received at 212 in process 200 can be used to train the ML model, so the ML model can update its predictions based on which users clicked on which UI elements. As such, when process 200 is performed in the future, recommendations can be more relevant to the user's interests.

At 602, system 100 can transform the event data into a training data format. As described above, the event data may be batched and/or otherwise compiled over a period of time. Each entry therein can be labeled with an EventID or other identifier associated with the instance in which the associated offer was displayed, and the entry can also include a reward value (e.g., 1 for click, 0 for no click, as described above). To transform the data, system 100 can write the data into a specific format tailored to the library being used for the training. For example, if using the library called vowpalwabbit, a format for one training sample can be as follows:
shared|User feature_name:feature_value
0:reward:probability
   |Action vertical:vertical_name partner:partner_name product:product_name
   |Action vertical:vertical_name partner:partner_name product:product_name
Or, to give a specific example:
shared|User user=Tom time_of_d
   |Action article=politics
   |Action article=sports
   |Action article=music
   |Action article=food

At 604, system 100 can train the ML model on the training data from 602. For example, system 100 can use standard ML training procedures where all parameters are updated in one training process and/or can use online learning procedures wherein each parameter of the model is trained and updated one by one with multiple training passes.

At 606, system 100 can deploy the model. For example, the model can be stored in memory of system 100 and/or a machine learning platform (e.g., a component of system 100, a separate component accessible to system 100, a cloud-based service, etc.). When process 200 is run again in response to a request payload being received, the retrained model will have been further refined and may therefore provide more relevant content for presentation in the UI of user device 10.

FIG. 7 shows a computing device 700 according to some embodiments of the disclosure. For example, computing device 700 may function as system 100 or any portion(s) thereof, or multiple computing devices 700 may function as system 100.

Computing device 700 may be implemented on any electronic device that runs software applications derived from compiled instructions, including without limitation personal computers, servers, smart phones, media players, electronic tablets, game consoles, email devices, etc. In some implementations, computing device 700 may include one or more processors 702, one or more input devices 704, one or more display devices 706, one or more network interfaces 708, and one or more computer-readable mediums 710. Each of these components may be coupled by bus 712, and in some embodiments, these components may be distributed among multiple physical locations and coupled by a network.

Display device 706 may be any known display technology, including but not limited to display devices using Liquid Crystal Display (LCD) or Light Emitting Diode (LED) technology. Processor(s) 702 may use any known processor technology, including but not limited to graphics processors and multi-core processors. Input device 704 may be any known input device technology, including but not limited to a keyboard (including a virtual keyboard), mouse, track ball, and touch-sensitive pad or display. Bus 712 may be any known internal or external bus technology, including but not limited to ISA, EISA, PCI, PCI Express, NuBus, USB, Serial ATA or FireWire. In some embodiments, some or all devices shown as coupled by bus 712 may not be coupled to one another by a physical bus, but by a network connection, for example. Computer-readable medium 710 may be any medium that participates in providing instructions to processor(s) 702 for execution, including without limitation, non-volatile storage media (e.g., optical disks, magnetic disks, flash drives, etc.), or volatile media (e.g., SDRAM, ROM, etc.).

Computer-readable medium 710 may include various instructions 714 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 may establish and maintain network connections (e.g., software for implementing communication protocols, such as TCP/IP, HTTP, Ethernet, telephony, etc.).

User feature/offer data elements 718 may include the user feature and/or offer lookup tables and/or the instructions that enable computing device 700 to perform data lookup and/or vector formation functions described above. Recommendation/ML instructions 720 may enable computing device 700 to perform recommendation and/or ML functions (e.g., training) described above. Application(s) 722 may be an application that uses or implements the processes described herein and/or other processes. In some embodiments, the various processes may also be implemented in operating system 714.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API and/or SDK, in addition to those functions specifically described above as being implemented using an API and/or SDK. An API may define one or more parameters that are passed between a calling application and other software code (e.g., an operating system, library routine, function) that provides a service, that provides data, or that performs an operation or a computation. SDKs can include APIs (or multiple APIs), integrated development environments (IDEs), documentation, libraries, code samples, and other utilities.

The API and/or SDK may be implemented as one or more calls in program code that send or receive one or more parameters through a parameter list or other structure based on a call convention defined in an API and/or SDK specification document. A parameter may be a constant, a key, a data structure, an object, an object class, a variable, a data type, a pointer, an array, a list, or another call. API and/or SDK calls and parameters may be implemented in any programming language. The programming language may define the vocabulary and calling convention that a programmer will employ to access functions supporting the API and/or SDK.

In some implementations, an API and/or SDK call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
receiving, by a processor, a request payload from an external device, the request payload including a user identifier;
generating, by the processor, a user feature vector from the user identifier;
receiving, by the processor, data describing a plurality of user interface (UI) elements configured to be presented in a UI of the external device;
using a contextual bandit machine learning (ML) model that takes the user feature vector and the data describing the plurality of UI elements as input, selecting, by the processor, at least one of the plurality of UI elements as at least one recommended UI element;
causing, by the processor, the at least one recommended UI element to be presented in the UI of the external device;
receiving, by the processor, event data indicating a user interaction with the at least one recommended UI element in the UI of the external device; and
training, by the processor, the ML model using the event data.

2. The method of claim 1, wherein:
the request payload further includes contextual data; and
generating the user feature vector includes adding the contextual data to data extracted from a database.

3. The method of claim 1, wherein generating the user feature vector comprises:
operating parallel computing threads to perform processing comprising looking up the user identifier in a lookup table;
obtaining user feature data from the lookup table; and
building the user feature identifier including the user feature data from the lookup table.

4. The method of claim 1, wherein the ML model selects the at least one recommended UI element by:
estimating a respective current reward value of each of the plurality of UI elements; and
applying at least one exploration algorithm to select the at least one recommended UI element according to the current reward value and an exploration strategy.

5. The method of claim 4, wherein the at least one exploration algorithm is a softmax exploration, an epsilon greedy exploration, or a combination thereof.

6. The method of claim 1, further comprising concatenating, by the processor, the user feature vector and respective entries of the data describing the plurality of UI elements and inputting the concatenation of the user feature vector and the respective entries into the ML model as the input for the selecting.

7. The method of claim 1, wherein the event data indicating the user interaction indicates that the at least one recommended UI element was correctly predicted by the ML model.

8. The method of claim 1, wherein the training comprises:
generating training data by adding the event data to additional event data compiled over a period of time; and
training the ML model on the training data.

9. A method comprising:
receiving, by a processor, a request payload from an external device, the request payload including a user identifier;
generating, by the processor, a user feature vector from the user identifier, the generating comprising:
operating parallel computing threads to perform processing comprising looking up the user identifier in a lookup table,
obtaining user feature data from the lookup table, and
building the user feature identifier including the user feature data from the lookup table;
receiving, by the processor, data describing a plurality of user interface (UI) elements configured to be presented in a UI of the external device;
concatenating, by the processor, the user feature vector and respective entries of the data describing the plurality of UI elements;
using a contextual bandit machine learning (ML) model that takes the concatenation of the user feature vector and the respective entries as input, selecting, by the processor, at least one of the plurality of UI elements as at least one recommended UI element, the selecting comprising:
estimating a respective current reward value of each of the plurality of UI elements, and
applying at least one exploration algorithm to select the at least one recommended UI element according to the current reward value and an exploration strategy;
causing, by the processor, the at least one recommended UI element to be presented in the UI of the external device;
receiving, by the processor, event data indicating a user interaction with the at least one recommended UI element in the UI of the external device; and
training, by the processor, the ML model using the event data, the training comprising:
generating training data by adding the event data to additional event data compiled over a period of time, and
training the ML model on the training data.

10. The method of claim 9, wherein:
the request payload further includes contextual data; and
generating the user feature vector includes adding the contextual data to data extracted from a database.

11. The method of claim 9, wherein the at least one exploration algorithm is a softmax exploration, an epsilon greedy exploration, or a combination thereof.

12. The method of claim 9, wherein the event data indicating the user interaction indicates that the at least one recommended UI element was correctly predicted by the ML model.

13. A system comprising:
a user feature database;
a user interface (UI) element database; and
a processor in communication with the user feature database and the UI element database and configured to communicate with an external device through at least one network, the processor being configured to perform processing comprising:
receiving a request payload from the external device, the request payload including a user identifier;
generating a user feature vector from the user identifier, the generating including obtaining user feature data from the user feature database;
obtaining data describing a plurality of UI elements from the UI element database, each of the UI elements being configured to be presented in a UI of the external device;
using a contextual bandit machine learning (ML) model that takes the user feature vector and the data describing the plurality of UI elements as input, selecting at least one of the plurality of UI elements as at least one recommended UI element;
sending the at least one recommended UI element to the external device;
receiving event data indicating a user interaction with the at least one recommended UI element in the UI of the external device; and
training the ML model using the event data.

14. The system of claim 13, wherein:
the request payload further includes contextual data; and
generating the user feature vector includes adding the contextual data to the user feature data.

15. The system of claim 13, wherein generating the user feature vector comprises:
operating parallel computing threads to perform processing comprising looking up the user identifier in a lookup table of the user feature database;
obtaining the user feature data from the lookup table; and
building the user feature identifier including the user feature data from the lookup table.

16. The system of claim 13, wherein the ML model selects the at least one recommended UI element by:
estimating a respective current reward value of each of the plurality of UI elements; and
applying at least one exploration algorithm to select the at least one recommended UI element according to the current reward value and an exploration strategy.

17. The system of claim 16, wherein the at least one exploration algorithm is a softmax exploration, an epsilon greedy exploration, or a combination thereof.

18. The system of claim 13, wherein the processing further comprises concatenating the user feature vector and respective entries of the data describing the plurality of UI elements and inputting the concatenation of the user feature vector and the respective entries into the ML model as the input for the selecting.

19. The system of claim 13, wherein the event data indicating the user interaction indicates that the at least one recommended UI element was correctly predicted by the ML model.

20. The system of claim 13, wherein the training comprises:
generating training data by adding the event data to additional event data compiled over a period of time; and
training the ML model on the training data.
